(19) United States
(12) Patent Application Publication
(10) Pub. No.: US 2012/0278140 A1
(43) Pub. Date: Nov. 1, 2012

(54) ENCOURAGING CONSUMER BEHAVIOR BY UNLOCKING DIGITAL CONTENT

(75) Inventors: Marc E. Mercuri, Bothell, WA (US); James O. Tisdale, Duvall, WA (US)

(73) Assignee: Microsoft Corporation, Redmond, WA (US)

(21) Appl. No.: 13/093,858

(22) Filed: Apr. 26, 2011

(51) Int. Cl. G06Q 30/00

(52) U.S. Cl. 705/14.1

(57) ABSTRACT

A dynamic incentive system is described herein that uses location data, customer demographics, and other information to make real-time targeted offers to consumers to encourage particular consumer behavior. The system provides incentives for consumers to visit a particular merchant's store. The system may offer to unlock a digital content item if the consumer goes to the merchant's store. Merchants can define various offers and conditions for which the consumer can earn the incentive. Thus, the dynamic incentive system provides incentives to help merchants sell products and services by reaching more consumers and reaching them in new ways that are highly relevant to the consumers' current activities and location.

### BACKGROUND

Products and services have been sold in many ways throughout history. With the rise of the Internet, selling products and services has only changed slightly. Web pages often provide additional information to consumers before a purchase, and can provide additional assistance such as maps, contact information, and so forth, that help the consumer identify appropriate products and services and complete a purchase.

A common problem in selling products and services is reaching the right consumers that are likely to want to make a purchase. Advertising is one general form of reaching consumers. Advertising typically has a call to action that is designed to motivate a consumer to take action. Most often, this action takes the form of incenting the consumer to purchase a product or service. Advertisers work hard to quantify the demographics of audiences that will be reached with a particular advertisement, so that merchants can advertise to consumers that are the most likely to buy the merchant's products or services. The Internet has provided additional refinements to advertising, such as the ability to associate advertisements with search keywords, in the hope that the search keywords are a good reflection of a consumer's current interests.

Despite these improvements, there are numerous unmet consumer needs and consumers that would buy a product or service that are not reached by current advertising methods. With advancements in mobile devices, and particularly the broad availability of consumer location information, there is quite a bit of additional consumer information that is not presently available to advertisers and merchants.

### SUMMARY

A dynamic incentive system is described herein that uses location data, customer demographics, and other information to make real-time targeted offers to consumers to encourage particular consumer behavior. In some embodiments, the system provides incentives for consumers to visit a particular merchant's store. The system may offer to unlock a digital content item if the consumer goes to the merchant's store. Merchants can define various offers and conditions for which the consumer can earn the incentive. The incentive may be provided by the merchant or may be matched to various incentives available from the system operator provided by other merchants. The system can match these two together to allow the first merchant to get visits to his store, and the second merchant to raise awareness of her digital content. Thus, the dynamic incentive system provides incentives to help merchants sell products and services by reaching more consumers and reaching them in new ways that are highly relevant to the consumers' current activities and location.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the dynamic incentive system, in one embodiment.

FIG. 2 is a flow diagram that illustrates processing of the dynamic incentive system to receive an offer from a merchant that incentivizes consumers to purchase the merchant's products or services, in one embodiment.

FIG. 3 is a flow diagram that illustrates processing of the dynamic incentive system to deliver an offer from a merchant to a consumer that incentivizes the consumer to purchase the merchant's products or services, in one embodiment.

FIG. 4 is a flow diagram that illustrates processing of the dynamic incentive system to define an offer that matches merchant and consumer needs, in one embodiment.

FIG. 5 is a flow diagram that illustrates processing of the dynamic incentive system to deliver an offer that matches merchant and consumer needs, in one embodiment.

FIG. 6 is a flow diagram that illustrates processing of the dynamic incentive system to receive an offer designed to change consumer behavior, in one embodiment.

FIG. 7 is a flow diagram that illustrates processing of the dynamic incentive system to deliver an offer designed to change consumer behavior, in one embodiment.

FIG. 8 is a flow diagram that illustrates processing of the dynamic incentive system to define a location-based offer for goods or services, in one embodiment.

FIG. 9 is a flow diagram that illustrates processing of the dynamic incentive system to deliver an offer for goods or services based on a consumer's current location, in one embodiment.

FIG. 10 is a block diagram that illustrates typical actors associated with the dynamic incentive system, in one embodiment.

### DETAILED DESCRIPTION

A dynamic incentive system is described herein that uses location data, customer demographics, and other information to make real-time targeted offers to consumers to encourage particular consumer behavior. In some embodiments, the system provides incentives for consumers to visit a particular merchant's store. For example, the system may offer to unlock a digital content item, such as a song by the consumer's favorite band, if the consumer goes to the merchant's store. Merchants can define various offers and conditions (e.g., spending a certain amount of time at the store) for which the consumer can earn the incentive. The incentive may be provided by the merchant or may be matched to various incentives available from the system operator provided by other merchants. For example, a merchant may be willing to pay a certain amount of money for each consumer visit to their store, and another merchant may be willing to hand out promotional material to consumers of the same demographic. The system can match these two together to allow the first merchant to get visits to his store, and the second merchant to raise awareness of her digital content.

In some embodiments, the dynamic incentive system receives information about the consumer, such as the consumer's schedule, past purchase history, demographic information (e.g., age, gender, and social groups), needs, or direct input (“I'm hungry”), and so forth. For example, the consumer may run an application on the consumer's smartphone or other mobile device that has access to information shared by the consumer. The system can use this information to present offers that are more relevant. For example, if the consumer gets a haircut roughly every four weeks, has availability in his afternoon schedule, and a local barber has submitted an offer with a schedule that matches the consumer's, the system may offer the consumer an incentive to visit the barber to get a haircut. In some embodiments, the offer for the haircut would only be made if the consumer were free during that time period and nearby. The incentive may include a coupon for a discount on the barber's services, an offer to unlock digital content, or any other incentive.

In some embodiments, the dynamic incentive system provides incentives to attempt to modify consumer behavior. For example, a particular type of merchant may want to reach the consumers of the merchant's competitors to try to win the consumers as customers. Thus, the system may present an offer from the merchant when consumers are detected at the location of a competitor or when the system predicts that the customer may be heading to the competitor to offer the consumers an incentive to visit the merchant's store. For example, a consumer at one restaurant may receive a coupon to visit another restaurant. The system may use any of the previously described information, such as past purchase history, to suggest appropriate offers to a particular consumer, and to match the consumer with offers submitted by particular merchants.

In some embodiments, the dynamic incentive system attempts to reach consumers that are already at a location to perform some behavior. For example, a store in a mall may want to reach out to visitors to the mall to let them know about a particular sale or product for which the store has excess inventory. Upon detecting that a matching consumer is at the location, the system may present an offer to the consumer informing the consumer of the merchant's offer. Thus, the dynamic incentive system provides incentives to help merchants sell products and services by reaching more consumers and reaching them in new ways that are highly relevant to the consumers' current activities and location.

In some embodiments, the dynamic incentive system uses location information and targeted offers to unlock digital marketing content and to encourage the consumer to visit a location. In this case, the content provides the incentive to the consumer, and the offer encourages behavior to visit a location previously defined by a merchant of a product or service. Many opportunities present themselves when the system can utilize the location of a consumer via a mobile device and utilize that (and potentially multiple other pieces of information) to drive engagement with a consumer. This engagement can incentivize a consumer to visit a physical location (e.g., a store or a department in a store), provide offers to people within a physical location (at the mall), and may consider secondary information (e.g., reputation, purchase history, and identified need). If the consumer visits the location, the merchant may gain increased sales and the consumer gains a wanted content item.

In some embodiments, the dynamic incentive system presents real-time limited offers to consumers based on location, purchase history, and assumed need. A merchant or a consumer can use the system to fill a schedule based on the needs of either. For example, an oil change shop may have no line on a slow afternoon, and can make offers to nearby consumers in real-time to come and get an oil change. The system may use information about each consumer such as whether the consumer owns a car, whether the consumer has purchased an oil change in the last few months, whether the consumer has time in the consumer's schedule for an oil change, and so forth without that detailed information ever being made available to the merchant. In this way, the system matches merchant needs to consumer needs in a way that facilitates commerce at a time that is convenient for all parties involved. In this example, the merchant may smooth out what would otherwise have been a busy weekend schedule by pushing more demand into the week, and the consumer may save a little money using a coupon that is part of the offer and get something done that the consumer needed to do anyway, during a time when the consumer was available. In such embodiments, the system focuses on matching any aspect of merchant or consumer needs together based on all of the available information from each.

In some embodiments, the dynamic incentive system uses location, consumer purchase history to present offers that attempt to change typical consumer behavior. In the previous example, the system incentivized the consumer to do something the consumer already typically does (e.g., get an oil change or a haircut through repeat business to a known merchant). In this example, the system incentivizes the consumer to do something new or to use a competing merchant for a common product or service. For example, a routine customer of restaurant X is nearby restaurant Y where the consumer has not dined before. Restaurant Y can generate an offer to encourage any nearby consumers with certain criteria to dine at restaurant Y. The incentive may include a coupon, offer for digital content, or other item desirable to the consumer. The system may make the offer based on information about the current time compared to the consumer's typical mealtime, the consumer's proximity to the new restaurant, the consumer's preference for a type of food served by the restaurant, and so forth. As another example, the system may present a consumer that is typically a customer of BP Gasoline with an offer for a nearby Shell Station for a free car wash with fill up. In this way, the system allows merchants to solicit new customers.

In some embodiments, the dynamic incentive system uses location, consumer reputation, demographics, and other information to present offers while a consumer is at a location that may unlock digital offers or provide other incentives to the consumer. In the earlier example, the system presented offers that incentivized consumers to visit a particular location. In this example, the system instead provides incentives to consumers because they are already at a particular location. The system can use location in conjunction with a consumer's reputation or other information to make a targeted offer that can be redeemed at nearby businesses. Some examples include: a) Restaurant A wishes to increase their traffic, (b) Restaurant B can provide discounts for students on the honor role, (c) Restaurant C can make dynamic offers to people on their birthday (even if they have not previously visited the restaurant before), (d) Restaurant D may wish to attract more members of a particular demographic (income, age, etc.) and offer targeted discounts, (e) Nightclub A may want to attract more women and offer free admission, (f) Bar B may be hosting a sporting event and invite a known fan who might otherwise be unaware of the bar, (g) a local bar, looking for more visibility, may provide discounts to people with a significant number of followers on Facebook, (h) a camera store may offer discounts to someone who has a lot of followers and is very active on Flickr or another social network, and (i) a local UPS Store may offer discounts or free packing materials to individuals that are Power Sellers on eBay or other merchants. These and other examples provide offers to the consumer based on the consumer's present location and some other information about the consumer that makes the offer particularly relevant to the merchant or consumer.

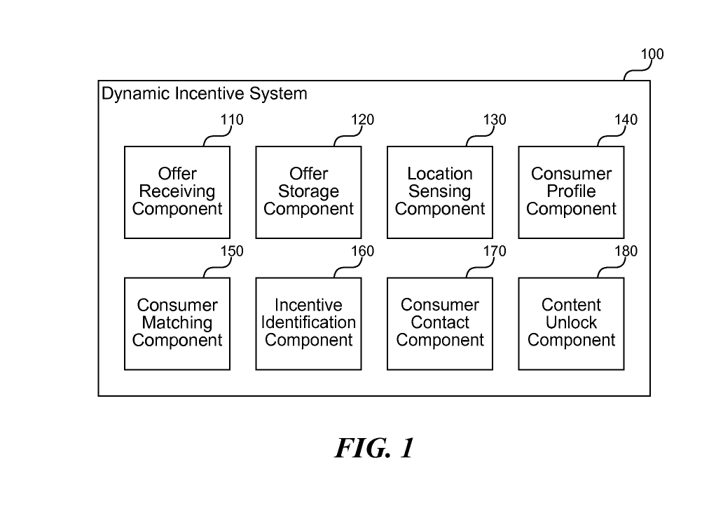

FIG. 1 is a block diagram that illustrates components of the dynamic incentive system, in one embodiment. The system 100 includes an offer receiving component 110, an offer storage component 120, a location sensing component 130, a consumer profile component 140, a consumer matching component 150, an incentive identification component 160, a consumer contact component 170, and a content unlock component 180. Each of these components is described in further detail herein.

The offer receiving component 110 receives one or more offers from one or more merchants, the offers designed to incentivize consumer behavior. The offer may include an indication of a desired behavior of a consumer, such as visiting a location associated with the merchant, completing a task, purchasing a product, recommending a product to a friend, and so on. The offer receiving component 110 may provide a user interface, such as a web page or software application, through which merchants can define, save, and activate various offers to consumers to promote the merchants' products and services. The offer receiving component 110 may also receive consumer profile information against which the merchant wants to match demographic and other information of eligible consumers as a precondition for the consumers to receive the offer. For example, a merchant may want to market a particular product to female consumers in a certain age range that have purchased hair products in the last week. The merchant can specify these and other conditions through the offer receiving component 110. The offer may include other criteria, such as a quantity of the incentive available, such that after that quantity of consumers have accepted or used the offer, the system stops matching new consumers with the offer. The offer receiving component 110 stores current offers in the offer storage component 120 for subsequent matching to consumers via the consumer matching component 150. The offers may include schedules or other time limitations that specify a period during which the offer is matched with consumers.

The offer storage component 120 stores one or more received offers for subsequent matching to consumers. The component 120 may include one or more file systems, hard drives, portable storage devices, databases, cloud-based storage services, or other data storage facility for persisting data over time. The offer storage component 120 stores offers and any associated conditions such as consumer profiles, offer schedules, and so forth. The component 120 is accessible by other components of the system 100 to perform various operations related to consumer offers.

The location sensing component 130 detects a consumer's current location with a device associated with the consumer and provides the detected location to other components of the system for presenting dynamic offers for products or services to the consumer. The device may include a mobile phone, keychain, watch, or any other device with a global positioning system (GPS), cell tower triangulation, or other hardware that can identify location. The location sensing component 130 may provide location information as latitude and longitude components, cross-streets, or other data point that allows merchants to associate offers with a particular location and allows the system to determine whether a consumer is within a predetermined proximity of the location. If the consumer is within the predetermined proximity of a location associated with the offer, then based on whether other conditions of the offer match the consumer, the consumer matching component 150 will select consumers to which to deliver the offer. In some embodiments, the component 130 identifies consumers that are at a location to which to present offers of merchants near the consumer.

The consumer profile component 140 gathers and provides profile information related to one or more consumers to components of the system 100 to match against one or more offer conditions that a merchant previously specified in an offer. In some embodiments, the component 140 gathers past consumer purchase information to identify purchases from competitors of a merchant that has submitted an offer designed to change consumer behavior to use the merchant's products or services. The consumer profile component 140 can gather purchase history, consumer needs, consumer schedule information (e.g., from a calendar application used by the consumer), demographic information (e.g., age, sex, height, social groups), and any other information associated with the consumer. The consumer profile component 140 may receive one or more privacy preferences from the consumer that indicate which information the consumer will allow the system 100 to use for matching the consumer with merchant offers. The consumer may choose not to share some information or to restrict the manner in which information is shared to a mode that allows anonymity. The component 140 attempts to provide the consumer with offers that the consumer will want to receive without sacrificing the consumer's privacy or exposing personal information. However, with the consumer's permission, the system may provide information to merchants that allows the merchants to more effectively select products, services, and offers of interest to the consumer.

The consumer matching component 150 matches one or more received offers to one or more consumers, based on the consumer's detected location and one or more conditions associated with the offer. The component 150 may match consumers to offers based on needs of the consumer, needs of the merchant (e.g., an open slot in the merchant's schedule or time-based quota for sales), consumer profile information versus profile criteria specified in the offer, one or more businesses associated with the consumer's current location, and so forth. The matching component 150 endeavors to find offers for the consumer that will result in the consumer purchasing a merchant's product. To this end, the component 150 may determine a relevance of a particular offer to a particular consumer based on information provided by the merchant, provided by the consumer, and/or determined by the system 100. For example, in some embodiments the component 150 determines needs of one or more merchants, needs of one or more consumers, and matches the determined needs to determine one or more pairs of consumers and merchants between which to exchange an offer for purchase of a product or service. The system 100 may track heuristics such as which types of consumers have responded positively to a particular incentive or offer, so that the system can adapt the matching and/or inform merchants what is working so merchants can design offers that are more effective.

The incentive identification component 160 determines an incentive that is likely to influence behavior of the consumer to perform an action associated with a selected merchant offer. In some cases, the merchant may explicitly specify an appropriate incentive at the time of defining the offer, so that if consumers perform a specified action they will receive the specified incentive. In some embodiments, the component 160 dynamically determines an appropriate incentive based on information such as how much the merchant is willing to pay to engage the consumer, interests of the consumer, other consumer profile information, incentives offered by other merchants, and so forth. The incentive may include unlocking digital content if the consumer performs the specified action, as handled by the content unlock component 180.

The consumer contact component 170 contacts one or more consumers to which the system 100 matched one or more merchant offers to inform the consumers of the offer and the determined incentive. For example, the component 170 may send the consumer a text message, email message, pop-up notification or other communication that indicates the details of the offer (e.g., merchant, call to action, and incentive) so the consumer can determine if the consumer will perform the specified behavior to receive the specified incentive. The consumer may reply to the offer by visiting the merchant, by indicating a willingness to accept the offer through a direct reply to the notification, or through other actions of the consumer (e.g., recommending the offer to one or more of the consumer's friends).

The content unlock component 180 unlocks content provided as an incentive to consumers upon determining that a particular consumer has performed a specified action for which the content is a reward. For example, if a merchant offer requests that a consumer visit the merchant's store with an incentive that indicates that the consumer will receive a free downloadable song, then the content unlock component 180 makes the song available to the consumer (e.g., through a direct download, emailed link, or other facility) after determining that the consumer has visited the store. The content unlock component 180 may use information such as the consumer's location as detected by the location sensing component 130 and the terms of the offer stored in the offer storage component 120 to determine whether to unlock particular content and which content to unlock in response to the consumer's actions. For example, in some embodiments, upon determining that a consumer has visited a location identified by a merchant offer, the content unlock component 180 provides the consumer with access to an identified digital content item.

The computing device on which the dynamic incentive system is implemented may include a central processing unit, memory, input devices (e.g., keyboard and pointing devices), output devices (e.g., display devices), and storage devices (e.g., disk drives or other non-volatile storage media). The memory and storage devices are computer-readable storage media that may be encoded with computer-executable instructions (e.g., software) that implement or enable the system. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, set top boxes, systems on a chip (SOCs), and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

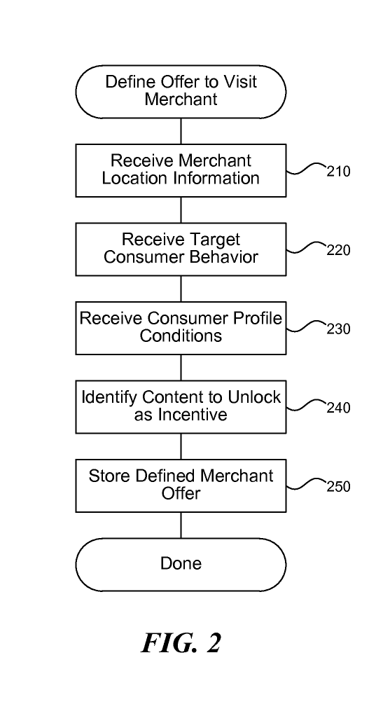

FIG. 2 is a flow diagram that illustrates processing of the dynamic incentive system to receive an offer from a merchant that incentivizes consumers to purchase the merchant's products or services, in one embodiment.

Beginning in block 210, the system receives identification information related to a merchant and one or more locations associated with the merchant. For example, the information may include a business name and a street address of the business. The system may provide a user interface through which merchants can enter their information in merchant profile or other stored record and create offers to incentivize consumers to visit their locations to purchase products or services. The merchant may define one or more offers through the user interface, which may include a web page, mobile application, or other interface through which merchants access the system.

Continuing in block 220, the system receives target consumer behavior that includes visiting a location associated with the merchant. The system helps merchants incentivize consumers to visit their business by communicating one or more offers from the merchant to the consumer and offering an incentive. The target consumer behavior may include receiving a signal from the consumer's mobile device indicating that the consumer is at the merchant's location, spending a certain amount of time at the merchant's location, visiting a particular sub-location (e.g., a department within a store), and so forth.

Continuing in block 230, the system receives one or more consumer profile conditions that filter the types of consumers that will receive an offer to visit the merchant's location. The profile conditions may include various information and criteria associated with consumers that is available to the system, such as demographic information, past purchase history, consumer preferences, social networks that the consumer participates in, and so on. The consumer profile conditions may also include information that is more dynamic, such as targeting consumers that are presently at a particular location or that have been at a particular location in recent times, targeting consumers within a certain distance of the merchant location, targeting consumers that are currently performing a particular activity, and so forth.

Continuing in block 240, the system identifies content to unlock as an incentive to entice consumers matching the received profile conditions to visit the merchant's location and perform the target consumer behavior. The system may receive a specific incentive or digital content item from the merchant during creation of the offer or may select an incentive from other sources, such as received third-party incentives and promotional material. The digital content may include a song, video, credits at a web-based store, items in a game, tickets to a movie, or any other unlockable content that the system can provide to the consumer as a reward for performing the target consumer behavior. For example, the system may provide the consumer with access to a preview video of a new movie in return for the consumer visiting the merchant's store for 10 minutes.

Continuing in block 250, the system stores a defined offer from the merchant that includes the received merchant information, target consumer behavior, consumer profile conditions, and identified digital content. The system may provide a market of merchant offers through an application run by consumers on a mobile or other device, such that the device at any given time can monitor and select appropriate offers based on the consumer's location, needs, current activities, and so forth. After block 250, these steps conclude.

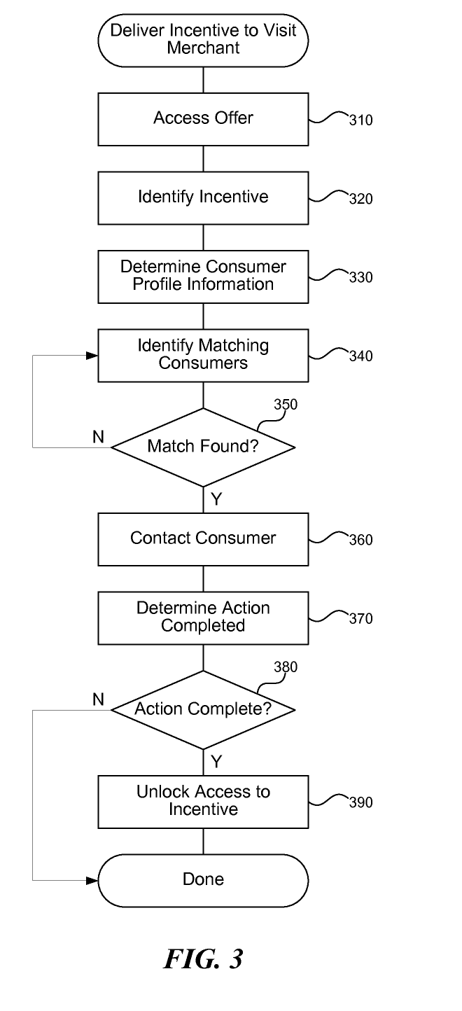

FIG. 3 is a flow diagram that illustrates processing of the dynamic incentive system to deliver an offer from a merchant to a consumer that incentivizes the consumer to purchase the merchant's products or services, in one embodiment.

Beginning in block 310, the system access a previously stored offer defined by a merchant to encourage target consumers to perform an identified behavior related to the merchant's products or services. For example, the offer may ask consumers to visit a location associated with the merchant to receive access to digital content. The system may store a pool of offers from which the system can select at any time and match to consumers that subscribe to a service or run a mobile application associated with the system.

Continuing in block 320, the system identifies an incentive relevant to the target consumers that will allow the consumer to unlock access to a reward based on actions of the consumers. The incentive may be specified by the merchant and stored with the previously stored offer or may be dynamically determined by the system. In some cases, a merchant may identify different incentives for different target consumers, such as passes to one movie for young adults and passes to a different movie for middle-aged adults (or by gender or other criteria).

Continuing in block 330, the system determines consumer profile information associated with the offer that defines which consumers are eligible to receive the offer. A merchant may want to limit the offer to the consumers that the merchant believes are most likely to accept the offer, and to those that will be most interested in the offer. There may be a cost to the merchant for offers made (either directly as charged by the system or indirectly as consumers develop a negative opinion of the merchant based on irrelevant offers), such that the merchant acts to make offers highly targeted and relevant to consumers.

Continuing in block 340, the system identifies one or more consumers that match the consumer profile information associated with the offer. The system may determine demographic information of the target consumers, past behavior information, or any other information about the consumers that helps the system to target offers more effectively. If the merchant specifies specific criteria (e.g., male consumers age 20-24 within 5 miles of the merchant's store), then the system monitors consumers using the system to determine any change that may cause a consumer to match a particular offer's criteria.

Continuing in decision block 350, if one or more matching consumers were found, then the system continues at block 360, else the system loops to block 340 to continue looking for matching consumers. Continuing in block 360, the system contacts the matching consumers and offers the identified incentive to each consumer in return for performing the identified behavior requested by the merchant offer. For example, the system may identify an email address, SMS phone number, device identifier for pop-up notification, or other contact address for reaching the consumer and send a message that indicates the offer and incentive. For example, the system may send a text message indicating that if the consumer visits Macy's three blocks away, the consumer can unlock access to passes to the latest Twilight movie.

Continuing in block 370, the system determines whether the consumer completed the identified behavior for receiving the incentive associated with the offer. For example, the system may use GPS hardware or other input information from a consumer's mobile device to determine that the consumer visited the merchant's store. The system may also capture other information that is a condition of receiving the incentive, such as how long the consumer spent at the merchant's location, whether the consumer purchased particular items, whether the consumer recommended the merchant to friends, and so forth. The system is flexible and allows merchants to define target consumer behavior that is most useful to the merchant and applicable to the merchant's particular business.

Continuing in decision block 380, if the system determines that the behavior was completed, then the system continues at block 390, else the system completes. Continuing in block 390, the system unlocks access to the identified incentive for the matching consumers that performed the identified behavior. Unlocking access may include informing a third party that the consumer can access the item, sending the consumer a link to the item, sending passes to an event to the consumer, or any other action that provides the consumer with access to the incentive. After block 390, these steps conclude.

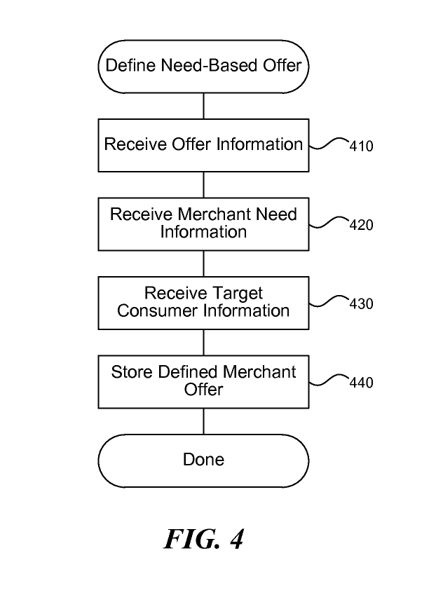

FIG. 4 is a flow diagram that illustrates processing of the dynamic incentive system to define an offer that matches merchant and consumer needs, in one embodiment.

Beginning in block 410, the system receives offer information from a merchant that defines behavior of consumers that the merchant wants to incentivize. For example, the offer may include a request that the consumer visit the merchant's store, a coupon for discounted products or services from the merchant, and so on. The system may provide a user interface through which merchants can enter offer information.

Continuing in block 420, the system receives information describing one or more specific needs of the merchant. For example, the merchant may have open appointment slots at particular times on a given day that the merchant would like to fill. The merchant may also have other needs, such as excess inventory that needs to be sold by a particular date, sales quotas for a particular month, and so forth. Often merchants receive incentives from their suppliers to sell a certain number of products in a given period to receive future products at a cheaper price. The merchant can leverage the dynamic incentive system to help the merchant meet such goals by encouraging consumer behavior that fits with the merchant's targets. In some cases, the system may provide an application or service that the merchant runs that automatically updates the system on the merchant's needs on a periodic schedule. For example, the application may provide the merchant's open appointment slots at the beginning of each day or on an hourly basis.

Continuing in block 430, the system receives target consumer information that defines a type of consumer that the merchant seeks that is likely to be interested in the merchant's products or services. The target consumer information may include an age range, gender, consumers with particular past purchase histories, consumers in a particular geographic location, consumers within a particular distance from the merchant, and so forth. In some cases, the merchant may provide a customer list of customers to which to target the offer. The system uses this information to match the merchant's needs with consumers that are likely to be able to fill those needs by visiting the merchant and purchasing the merchant's products or services.

Continuing in block 440, the system stores a defined merchant offer that includes the received offer information, merchant needs, and target consumer information. The system may provide a market of merchant offers through an application run by consumers on a mobile or other device, and the application may match consumer needs with merchant needs to help facilitate commerce between the merchant and consumers. In some embodiments, the system may provide plug-ins or APIs for use with other offer markets such as Groupon or LivingSocial, whereby a merchant can direct offers already placed with these markets to consumers through the dynamic incentive system. After block 440, these steps conclude.

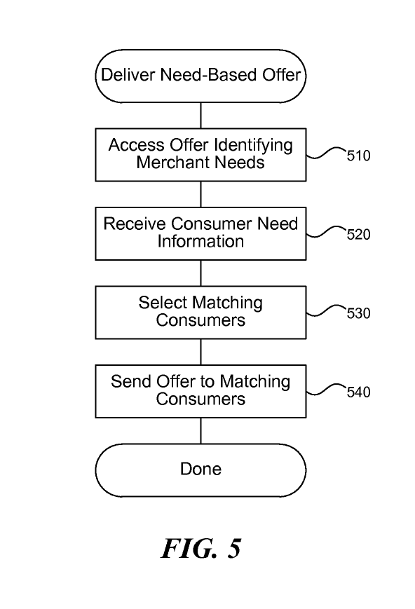

FIG. 5 is a flow diagram that illustrates processing of the dynamic incentive system to deliver an offer that matches merchant and consumer needs, in one embodiment.

Beginning in block 510, the system accesses a previously stored offer from a merchant that identifies one or more needs of the merchant for handling consumer requests for products or services. For example, the offer may identify time slots of the merchant that are current unscheduled and for which the merchant would like to fill appointments for new consumers. The offer may include criteria for consumers to receive the offer, such as consumers in a target radius of the merchant's business location, existing versus new customers, and so forth.

Continuing in block 520, the system receives information from one or more consumers identifying needs of the consumers for identified products or services. For example, the system may receive past purchase history information that indicates that the consumer typically gets a haircut or oil change every four weeks and has not purchased one in the last four weeks. This may indicate that the consumer has a need for a haircut or oil change, and the system can match the consumer with merchants that provide these services and have corresponding needs, such as open appointment slots. The system may also receive other information, such as the consumer's schedule, so that the system can coordinate when the consumer and merchant are mutually available to carry out a transaction.

Continuing in block 530, the system selects one or more consumers whose identified needs match those of the merchant. For example, a consumer that needs to eat may be matched with a merchant that operates a restaurant with empty tables. The system may also apply other criteria associated with the offer to filter consumers. For example, the merchant may prefer to make an offer to existing customers to encourage repeat business rather than new customers who may be less interested in the merchant's products or services.

Continuing in block 540, the system sends the offer to the selected consumers identifying the availability of the merchant and the ability of the merchant to meet at least one of the consumers' identified needs. The system may send the offer to an address associated with the consumer through the system, such as a mobile phone number, email address, or other contact point of the consumer. The system may determine how many consumers to contact based on information specified by the merchant in the offer. In some cases, the system may send more offers than the merchant's actual availability, recognizing a typically less than 100% acceptance rate of offers. The system may also receive cascading offers from the merchant, such that an incentive becomes more rewarding as the unfilled time slots of the merchant approach (e.g., 10% off for offers in the morning to fill an afternoon time slot, but 25% off for offers sent closer to the unfilled time slot). After block 540, these steps conclude.

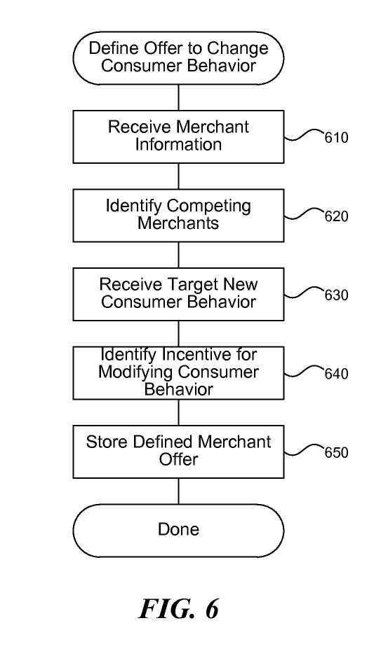

FIG. 6 is a flow diagram that illustrates processing of the dynamic incentive system to receive an offer designed to change consumer behavior, in one embodiment.

Beginning in block 610, the system receives identification information related to a merchant and one or more locations associated with the merchant. For example, the information may include a business name and a street address of the business. The system may provide a user interface through which merchants can enter their information in merchant profile or other stored record and create offers to incentivize consumers to visit their locations to purchase products or services. The merchant may define one or more offers through the user interface, which may include a web page, mobile application, or other interface through which merchants access the system.

Continuing in block 620, the system identifies one or more competitors of the merchant and one or more locations associated with the identified competitors. For example, if the merchant operates a gas station, then the system may identify competing gas stations near the merchant's location. Similarly, the merchant may operate a grocery store, department store, barbershop, or any other type of business that has nearby competitors. Consumers often develop habits that include visiting a particular merchant, and the system encourages consumers to break those habits and visit the merchant instead of his competitors based on some incentive.

Continuing in block 630, the system receives target new behavior that the merchant wants to encourage from consumers. For example, the target behavior may include buying flowers from the merchant instead of the merchant's competitors, or getting an oil change more frequently. In some cases, the merchant may provide an add-on product or service that complements other merchants' products or services, and in other cases the merchant's products or services may be substitutes for that of competitors. The target behavior defines the merchant's end goal for the consumer's behavior.

Continuing in block 640, the system identifies an incentive for modifying the consumer's behavior to perform the target new behavior. The system may receive a specific incentive from the merchant or identify one automatically. The incentive may include unlocking a digital content item, providing a discount to the consumer, sending the consumer free promotional items, or any other incentive that rewards the consumer for performing the target new behavior.

Continuing in block 650, the system stores a defined offer including the received merchant information, competitor information, target new behavior, and identified incentive. The system may provide a market of merchant offers through an application run by consumers on a mobile or other device, and the application may match consumers with merchant offers to facilitate transactions between the merchant and consumers. After block 650, these steps conclude.

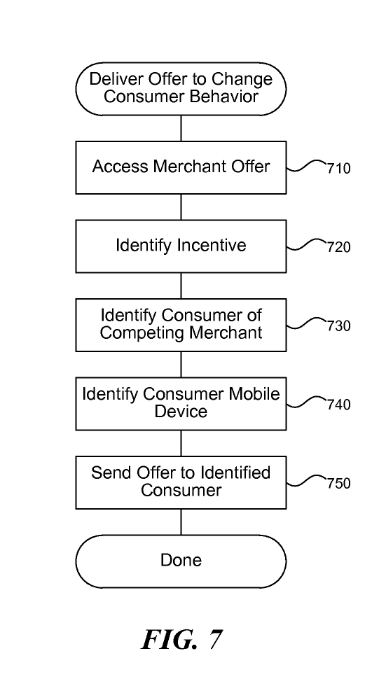

FIG. 7 is a flow diagram that illustrates processing of the dynamic incentive system to deliver an offer designed to change consumer behavior, in one embodiment.

Beginning in block 710, the system accesses an offer from a first merchant that includes an incentive to encourage consumers of a competing merchant to purchase products or services from the first merchant, wherein the competing merchant is a competitor of the first merchant. For example, the system may maintain a database of offers accessed by an application operating on a consumer's mobile device to identify offers relevant to the consumer based on the consumer's location, preferences, past purchase history, and so on.

Continuing in block 720, the system identifies an incentive associated with the accessed offer to offer to consumers as a reward for visiting the first merchant. For example, the system may offer a discount on products that the consumer purchases regularly as identified by the consumer's past purchase history, if the consumer purchases the items from the first merchant. The system may also offer free additional products, buy one get one free offers, third party content (e.g., a movie ticket), and so forth.

Continuing in block 730, the system identifies one or more consumers that are associated with the competing merchant to which to target the offer. For example, the system may use current consumer location information to identify consumers that are at or on the way to the competing merchant's location, and provide the offer to those consumers. The system attempts to change the consumer's typical behavior by offering the consumer an incentive to visit the first merchant instead of a competitor. The system may determine an opportune time (e.g., based on the consumer's regular schedule for purchasing a product or particular need) to present the offer to the consumer.

Continuing in block 740, the system identifies a mobile device of an identified consumer through which the consumer can be contacted. For example, the consumers may run an application associated with the system or provide contact information through a web site or other user interface provided by the system. In some embodiments, the system uses GPS or other hardware of the consumer's mobile device to present offers based on the consumer's location and other criteria associated with one or more merchant offers.

Continuing in block 750, the system sends the offer to the identified consumer via the identified mobile device to encourage the consumer to perform an action relative to the first merchant. For example, the action may include visiting the first merchant's store, purchasing the merchant's products, and so forth. The system may monitor the user's behavior after sending the offer to provide reports to the first merchant on the effectiveness of the offer. For example, the system may track how many consumers accept the offer, whether they visit the merchant's store, and so on. After block 750, these steps conclude.

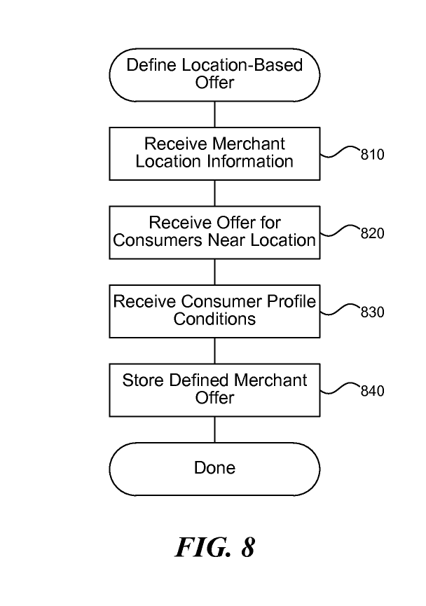

FIG. 8 is a flow diagram that illustrates processing of the dynamic incentive system to define a location-based offer for goods or services, in one embodiment.

Beginning in block 810, the system receives identification information related to a merchant and one or more locations associated with the merchant. For example, the information may include a business name and a street address of the business. The system may provide a user interface through which merchants can enter their information in merchant profile or other stored record and create offers to incentivize consumers to visit their locations to purchase products or services. The merchant may define one or more offers through the user interface, which may include a web page, mobile application, or other interface through which merchants access the system.

Continuing in block 820, the system receives an offer from the merchant that identifies one or more incentives to offer to consumers within a predetermined proximity of any of the merchant's one or more locations. For example, the system may receive a discount to offer to consumers in a mall that includes one of the merchant's stores to encourage the consumers to visit the merchant's store while they are nearby. The system uses the consumer's proximity to various merchants to present offers to the consumer that are related to the consumer's current location. A consumer near a merchant is much more likely to visit the merchant's location if encouraged to do so.

Continuing in block 830, the system receives one or more consumer profile conditions that filter the types of consumers that will receive an offer to visit the merchant's location. The profile conditions may include various information and criteria associated with consumers that is available to the system, such as demographic information, past purchase history, consumer preferences, social networks that the consumer participates in, and so on. The consumer profile conditions may filter based on any variety of consumer characteristics. For example, the merchant can target students on the honor role at school, consumers of a particular income level, consumers with an upcoming birthday, fans of a particular sport, or any other criteria that the merchant can define and the system can capture to match to the consumer. The consumer profile conditions may also include information that is more dynamic, such as targeting consumers that are presently at a particular location or that have been at a particular location in recent times, targeting consumers within a certain distance of the merchant location, targeting consumers that are currently performing a particular activity, and so forth.

Continuing in block 840, the system stores the offer from the merchant, including the merchant location information and received consumer profile conditions. The system may provide a market of merchant offers through an application run by consumers on a mobile or other device, and the application may match consumers with merchant offers to facilitate transactions between the merchant and consumers. The system presents offers to consumers that come near the merchant's location. After block 840, these steps conclude.

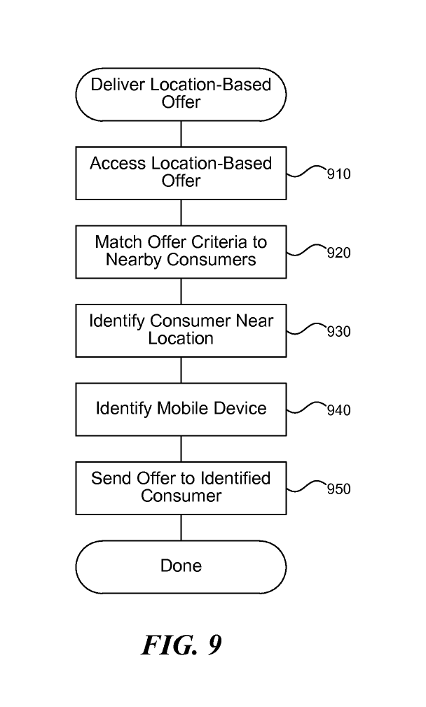

FIG. 9 is a flow diagram that illustrates processing of the dynamic incentive system to deliver an offer for goods or services based on a consumer's current location, in one embodiment.

Beginning in block 910, the system accesses an offer from a merchant directed to consumers that are at a particular location relative to the merchant, wherein the offer includes an incentive to encourage the consumers to perform an action relative to the merchant. For example, the offer may define a scope of consumers in a mall or within one mile of the merchant. The location may include a distance, driving time, conceptual distance (e.g., within a shopping center), and so on.

Continuing in block 920, the system matches one or more criteria associated with the offer to one or more profiles of consumers at the particular location to identify consumers to receive the offer. For example, the criteria may filter consumers to receive the offer based on age, product preferences, income level, whether the consumer owns a car, or any other criteria relevant to the merchant for identifying consumers likely to enter a transaction with the merchant to buy the merchant's products or services.

Continuing in block 930, the system identifies a consumer near the location of the merchant. For example, the system may receive periodically updated location information from an application running on a device associated with various consumers, and upon detecting that a consumer has passed close enough to the merchant the system may present the offer to the consumer.

Continuing in block 940, the system identifies a mobile device of the identified consumers through which the consumer can be contacted. For example, the consumers may run an application associated with the system or provide contact information through a web site or other user interface provided by the system. In some embodiments, the system uses GPS or other hardware of the consumer's mobile device to present offers based on the consumer's location and other criteria associated with one or more merchant offers.

Continuing in block 950, the system sends the offer to the identified consumer to encourage the consumer to visit the merchant and purchase the merchant's products or services. The system may monitor the consumer's behavior after sending the offer to provide reports to the first merchant on the effectiveness of the offer. For example, the system may track how many consumers accept the offer, whether they visit the merchant's store, and so on. After block 950, these steps conclude.

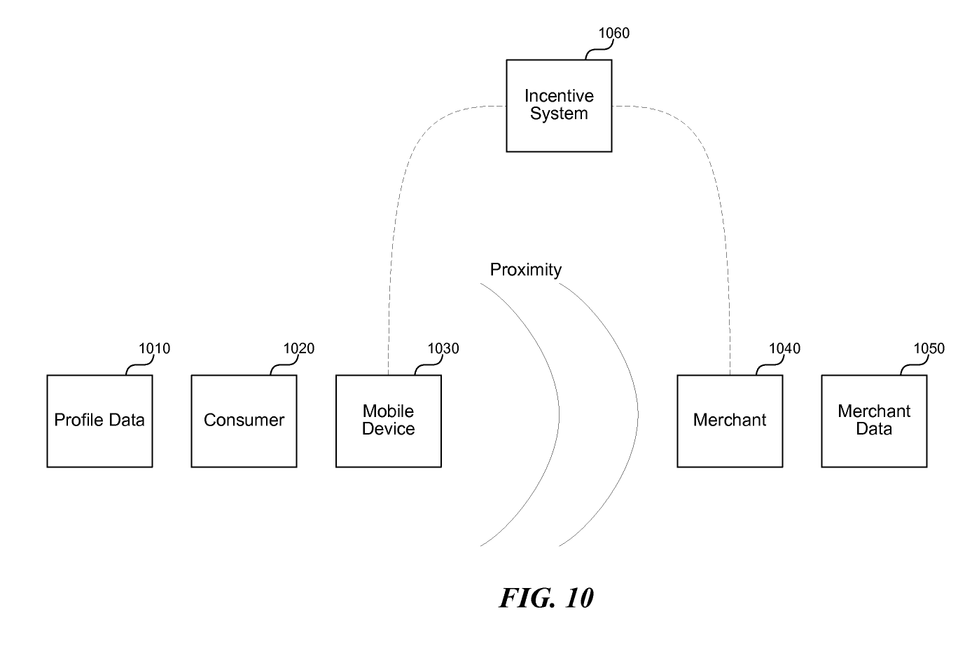

FIG. 10 is a block diagram that illustrates typical actors associated with the dynamic incentive system, in one embodiment. A consumer 1020 has a mobile device 1030 and associated profile data 1010 that may be stored on the mobile device 1030 with the incentive system 1060, or elsewhere. A merchant 1040 has merchant data 1050 that may include offers, incentives, location information, or other data. Based on the proximity of the mobile device 1030 to the merchant 1040, or based on other criteria, the incentive system 1060 delivers offers to the consumer's mobile device 1030 to incentivize the consumer 1020 to purchase products or services from the merchant 1040. The merchant 1040 can tailor offers along a variety of criteria to reach various consumers and meet various needs of the merchant 1040 and/or consumers.

### Alternative Applications

In some embodiments, the dynamic incentive system provides consumer need information to merchants without directly exposing private information of the consumer. Consumers using the system can receive finely tuned offers based on likes/dislikes, actions, location, and so forth, and in doing so they do not necessarily have to give up any private information to a merchant or advertiser. The consumer shares needs with the system, but not personally identifiable information. For example, the system may receive information that a consumer is hungry and search for restaurants near the consumer that have available offers, but not tell the restaurant the consumer's identity. Similarly, if a merchant wants to reach consumers that fit a particular profile (e.g., live in a specific zip code, have a certain income level, of a certain age), the system can find such consumers and print offers without providing the consumers' information to the merchant. Thus, the system receives highly personalized sets of criteria without necessarily exposing personal information. In some situations, consumers may choose to provide personal information in exchange for some benefit, but the system can operate without them doing so.

From the foregoing, it will be appreciated that specific embodiments of the dynamic incentive system have been described herein for purposes of illustration, but that various modifications may be made without deviating from the spirit and scope of the invention. Accordingly, the invention is not limited except as by the appended claims.

I/We claim:

1. A computer-implemented method for delivering an offer from a merchant to a consumer that incentivizes the consumer to purchase the merchant's products or services, the method comprising:
accessing a previously stored offer defined by a merchant to encourage target consumers to perform an identified behavior related to the merchant's products or services;
identifying an incentive relevant to the target consumers that will allow a consumer to unlock access to a reward based on actions of the consumer;
determining consumer profile information associated with the offer that defines which consumers are eligible to receive the offer;
identifying one or more consumers that match the consumer profile information associated with the offer; and
upon identifying a matching consumer, contacting the matching consumer and offering the identified incentive to the consumer in return for performing the identified behavior requested by the merchant offer,
wherein the preceding steps are performed by at least one processor.

2. The method of claim 1 wherein accessing the previously stored offer comprises an offer that asks consumers to visit a location associated with the merchant to receive access to digital content.

3. The method of claim 1 wherein accessing the previously stored offer comprises accessing a stored pool of offers to which to match consumers that subscribe to a service for receiving targeted offers.

4. The method of claim 1 wherein accessing the previously stored offer comprises accessing a stored pool of offers to which to match consumers that run a mobile application for receiving targeted offers.

5. The method of claim 1 wherein identifying an incentive comprises accessing an incentive specified by the merchant and stored with the previously stored offer.

6. The method of claim 1 wherein identifying an incentive comprises dynamically determining an incentive based on characteristics of the consumer.

7. The method of claim 1 wherein identifying an incentive comprises selecting between different incentives specified by the merchant for different target consumers.

8. The method of claim 1 wherein determining consumer profile information comprises limiting the offer to the consumers that the merchant identifies as most likely to accept the offer.

9. The method of claim 1 wherein identifying matching consumers comprises determining demographic information of the target consumers.

10. The method of claim 1 wherein identifying matching consumers comprises determining past behavior information of the target consumers.

11. The method of claim 1 wherein identifying matching consumers comprises monitoring consumers to determine any change that may cause a consumer to match a particular offer's criteria.

12. The method of claim 1 wherein contacting the consumer comprises identifying an email address, SMS phone number, device identifier, or other contact address for reaching the consumer and sending a message that indicates the offer and incentive.

13. The method of claim 1 further comprising determining whether the consumer completed the identified behavior for receiving the incentive associated with the offer, and upon determining that the action was completed, unlocking access to the identified incentive.

14. A computer system for encouraging consumer behavior by unlocking digital content, the system comprising:
a processor and memory configured to execute software instructions embodied within the following components;
an offer receiving component that receives one or more offers from one or more merchants, the offers designed to incentivize consumer behavior by unlocking digital content in return for a consumer action;
an offer storage component that stores one or more received offers for subsequent matching to consumers;
a location sensing component that detects a consumer's current location with a device associated with the consumer and provides the detected location to other components of the system for presenting dynamic offers for products or services to the consumer;
a consumer profile component that gathers and provides profile information related to one or more consumers to components of the system to match against one or more offer conditions that a merchant previously specified in an offer;
a consumer matching component that matches one or more received offers to one or more consumers, based on the consumer's detected location and one or more conditions associated with the offer;
an incentive identification component that determines an incentive that is likely to influence behavior of the consumer to perform an action associated with a selected merchant offer;
a consumer contact component that contacts one or more consumers to which the system matched one or more merchant offers to inform the consumers of the offer and the determined incentive; and
a content unlock component that unlocks content provided as an incentive to consumers upon determining that a particular consumer has performed a specified action for which the content is a reward.

15. The system of claim 14 wherein the offer receiving component receives an identification of a target consumer behavior and a digital content item to unlock in return for completing the behavior.

16. The system of claim 14 wherein the consumer matching component matches consumers based on determining that a consumer has not previously visited the merchant's location.

17. The system of claim 14 wherein the incentive identification component identifies a digital content item that is appropriate for the consumer based on consumer profile information that describes the consumer.

18. The system of claim 14 wherein the content unlock component unlocks the content after the consumer visits a location associated with the merchant.

19. A computer-readable storage medium comprising instructions for controlling a computer system to receive an offer from a merchant that incentivizes consumers to purchase the merchant's products or services, wherein the instructions, upon execution, cause a processor to perform actions comprising:
receiving identification information related to a merchant and one or more locations associated with the merchant;
receiving target consumer behavior that includes visiting a location associated with the merchant;
receiving one or more consumer profile conditions that filter the types of consumers that will receive an offer to visit the merchant's location;
identifying content to unlock as an incentive to entice consumers matching the received profile conditions to visit the merchant's location and perform the target consumer behavior; and
storing a defined offer from the merchant that includes the received merchant information, target consumer behavior, consumer profile conditions, and identified digital content.

20. The medium of claim 19 wherein the system helps merchants incentivize consumers to visit their business by communicating one or more offers from the merchant to the consumer and offering a content item that will be unlocked if the consumer visits the merchant's business.
